(19) United States
(12) Patent Application Publication
(10) Pub. No.: US 2026/0032200 A1
(43) Pub. Date: Jan. 29, 2026

(54) COMMUNICATION SYSTEM, MANAGEMENT SERVER, AND DEVICE

(71) Applicant: BROTHER KOGYO KABUSHIKI KAISHA, Nagoya (JP)

(72) Inventors: Tomohiro INAGAKI, Nagoya (JP); Katsuaki ITO, Nagoya (JP)

(21) Appl. No.: 19/273,348

(22) Filed: Jul. 18, 2025

(30) Foreign Application Priority Data
Jul. 26, 2024 (JP) 2024-120734

(51) Int. Cl. H04N 1/00; H04N 1/32; H04N 1/44

(52) U.S. Cl. CPC H04N 1/00244; H04N 1/32101; H04N 1/4426; H04N 2201/3277

(57) ABSTRACT

In response to a reset instruction, a device controller transmits a start notification to a server system. In a case where the start notification is received by the server system, a server controller transmits a start response to a device. In a first particular case where the start response is received by the device, the device controller performs a reset process including deleting setting information from a memory. In response to progress of the reset process to a particular stage, the device controller transmits a progress notification to the server system. In a second particular case where the progress notification is received by the server system, the server controller deletes device information from a first storage area and transmits a progress response to the device. In a third particular case where the progress response is received by the device, the device controller performs remainder of the reset process.

### REFERENCE TO RELATED APPLICATIONS

This application claims priority from Japanese Patent Application No. 2024-120734 filed on Jul. 26, 2024. The entire content of the priority application is incorporated herein by reference.

### BACKGROUND ART

Services provided using a server and a device, such as a printing subscription service, are known.

### SUMMARY

Users may subscribe to various services. The user may cancel the services. For example, the user cancels a service to be cancelled, by using a function of robotic process automation (RPA). A cancellation processing unit implemented by the RPA activates a web browser at a particular timing and performs a cancellation process on the web browser. The cancellation processing unit activates an application of the service to be cancelled at a particular timing and performs the cancellation process on the application.

Various services, such as a printing subscription service, are provided using a server and a device. Each of the server and the device stores various types of information used for the service. The user may delete information of the device when canceling the service. Here, there is a possibility that information inconsistency occurs between the device and the server.

In view of the foregoing, an example of an object of this disclosure is to provide a technique for reducing the possibility of information inconsistency between a device and a server.

According to one aspect, this specification discloses a communication system including a server system and a device used for a service. The server system includes a server controller and a first storage area. The first storage area is configured to store device information and user information in association with each other. The device information indicates the device. The user information indicates a user associated with the service. The device includes a device controller and a memory. The memory is configured to store the device information and setting information. The setting information indicates a setting used for the service. The device controller is configured to, in response to a reset instruction by a user of the device, transmit a start notification to the server system. The start notification is a notification including the device information. The server controller is configured to, in a case where the start notification is received by the server system, transmit a start response to the device. The start response is a response to the start notification. The device controller is configured to, in a first particular case where the start response is received by the device, perform a reset process including deleting the setting information from the memory of the device. The device controller is configured to, in response to progress of the reset process to a particular stage, transmit a progress notification to the server system. The progress notification indicates the progress of the reset process to the particular stage. The server controller is configured to, in a second particular case where the progress notification is received by the server system, perform a process for deleting the device information from the first storage area of the server system and transmit a progress response to the device. The progress response is a response to the progress notification. The device controller is configured to, in a third particular case where the progress response is received by the device, perform a remainder of the reset process.

According to this configuration, the device controller and the server controller use the start notification, the start response, the progress notification, and the progress response to proceed with the reset process including the process of deleting the device information from the first storage area of the server system and deleting the setting information from the memory of the device. Thus, the possibility of occurrence of information inconsistency between the device and the server system is reduced.

According to another aspect, this specification also discloses a management server configured to communicate with a service server and a device used for a service. The management server includes a server controller. The service server includes a first storage area configured to store device information and user information in association with each other. The device information indicates the device. The user information indicates a user associated with the service. The device includes a memory configured to store the device information and setting information. The setting information indicates a setting used for the service. The server controller is configured to, in a particular case where a progress notification from the device is received by the management server, transmit, to the service server, an instruction to delete the device information from the first storage area of the service server. The progress notification is a notification transmitted by the device in response to progress of a reset process to a particular stage. The reset process includes deleting the setting information from the memory of the device.

According to this configuration, the server controller transmits the instruction to delete the device information from the first storage area of the service server to the service server in the particular case where the progress notification from the device is received by the management server. Thus, the possibility of occurrence of information inconsistency between the device and the service server is reduced.

According to still another aspect, this specification also discloses a device used for a service and configured to communicate with a server system. The device includes a device controller and a memory. The memory is configured to store device information and setting information. The device information indicates the device. The setting information indicates a setting used for the service. The device controller is configured to, in response to a reset instruction by a user of the device, transmit a start notification to the server system. The start notification is a notification including the device information. The device controller is configured to, in a case where a start response is not received by the device before a first waiting time elapses from transmission of the start notification, not start a reset process including deleting the setting information from the memory of the device. The start response is a response from the server system in response to the start notification. The device controller is configured to, in a case where the start response is received by the device before the first waiting time elapses from the transmission of the start notification, start the reset process. The device controller is configured to, in response to progress of the reset process to a particular stage, transmit a progress notification to the server system. The progress notification indicates the progress of the reset process to the particular stage. The device controller is configured to, in a particular case where a progress response is received by the device, perform a remainder of the reset process. The progress response is a response from the server system in response to the progress notification.

According to this configuration, the device controller proceeds with the reset process by using the start notification, the start response, the progress notification, and the progress response. Thus, the possibility that the information in the device is not consistent with the information in the server system is reduced.

The technique disclosed in the present specification may be realized in various modes, and may be realized in modes such as an information processing method, a communication system, a server system, a device, a management server, a service server, a computer program for realizing functions of the method, the system, the device, and the server, and a recording medium (for example, a non-transitory computer-readable storage medium) in which the computer program is recorded.

### BRIEF DESCRIPTION OF DRAWINGS

FIG. 1 is a schematic diagram showing a communication system.

FIG. 2A is a diagram illustrating an example of a service database D3.

FIG. 2B is a diagram illustrating an example of a management database D4.

FIG. 3 is a sequence diagram illustrating an example of a reset process and a server process.

FIG. 4 is a sequence diagram illustrating the example of the reset process and the server process.

FIG. 5 is a sequence diagram illustrating the example of the reset process and the server process.

FIG. 6 is a sequence diagram illustrating the example of the reset process and the server process.

### DESCRIPTION

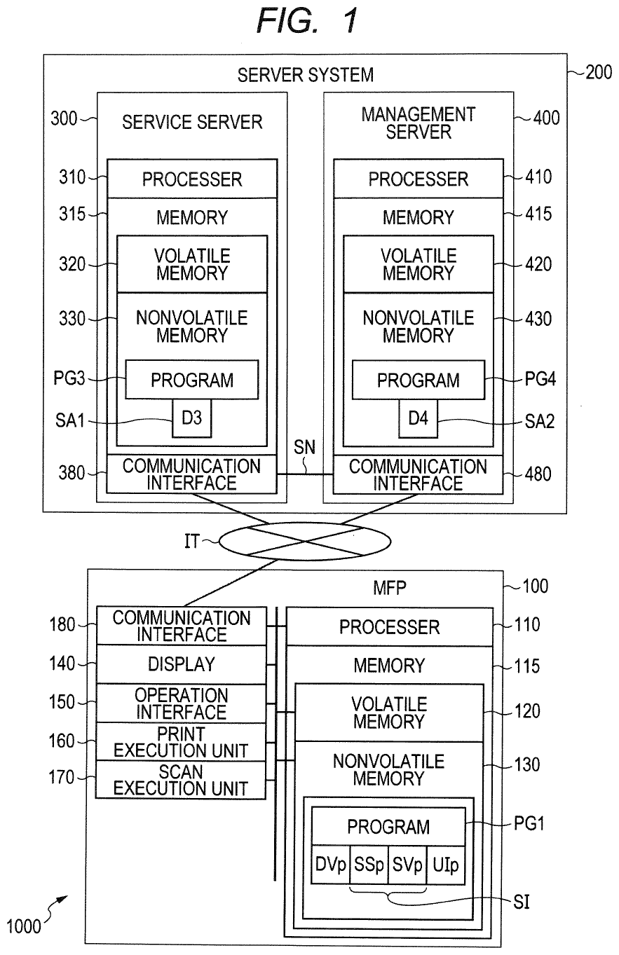

First, the configuration of a system will be described. FIG. 1 is a schematic diagram illustrating a communication system as an embodiment. A communication system 1000 includes a multifunction peripheral (MFP) 100 and a server system 200. The server system 200 includes a service server 300 and a management server 400. These devices 100, 300, and 400 are connected to a network IT. The network IT may include the so-called Internet. The network IT may include a so-called local area network.

The MFP 100 includes a processor 110, a memory 115, a display 140, an operation interface 150, a print execution unit (print engine) 160, a scan execution unit (scanner) 170, and a communication interface 180. These elements are connected to each other via a bus. The memory 115 includes a volatile memory 120 and a nonvolatile memory 130.

The processor 110 is a device configured to perform data processing, and is, for example, a central processing unit (CPU) or a system on a chip (SoC). The volatile memory 120 is, for example, a dynamic random access memory (DRAM), and the nonvolatile memory 130 is, for example, a flash memory. The nonvolatile memory 130 stores a program PG1, device information DVp, communication information SSp, service information SVp, and user setting information UIp. The program PG1 is stored in the nonvolatile memory 130 by the manufacturer of the MFP 100 when the MFP 100 is manufactured. Alternatively, the program PG1 may be downloaded from a server (not shown). Details of the information DVp, SSp, SVp, and UIp will be described later.

The display 140 is a device configured to display an image, and is a liquid crystal display or an organic EL display, for example. The operation interface 150 is a device configured to receive an operation by a user, and includes a button, a lever, or a touch panel disposed on the display 140 in an overlapping manner, for example. The display 140 and the operation interface 150 may be a so-called touch screen. The user may input various requests and instructions to the MFP 100 by operating the operation interface 150. The display 140 may display an element for operation (for example, a button or a slider), and the displayed element may be operated through an operation of the operation interface 150.

The print execution unit 160 is a device that prints an image. In the present embodiment, the print execution unit 160 is a so-called inkjet printer. The print execution unit 160 is configured to print an image using one or more types of printing materials (for example, four colors of ink, cyan, magenta, yellow, and black). The print execution unit 160 may be a device that prints an image in another method (for example, a laser printer).

The scan execution unit 170 is a device that optically reads (scans) an object such as a document. In the present embodiment, the scan execution unit 170 includes an optical sensor (not shown). The scan execution unit 170 optically reads an object to generate scan data representing the read object.

The communication interface 180 is an interface for communicating with other devices (for example, including one or more of a USB interface, a wired LAN interface, and an IEEE802.11 wireless interface). In the present embodiment, the communication interface 180 is connected to the network IT.

Next, a hardware configuration of the servers 300 and 400 will be described. In the present embodiment, the servers 300 and 400 have similar hardware configurations. Hereinafter, the configuration of the service server 300 and the configuration of the management server 400 will be described together.

The servers 300 and 400 include processors 310 and 410, memories 315 and 415, and communication interfaces 380 and 480, respectively. In each of the servers 300 and 400, these elements are connected to each other via a bus (not shown). The memories 315 and 415 include volatile memories 320 and 420 and nonvolatile memories 330 and 430.

The processors 310 and 410 are devices configured to perform data processing, for example, a CPU or a SoC. The volatile memories 320 and 420 are, for example, DRAMs, and the nonvolatile memories 330 and 430 are, for example, flash memories. The communication interfaces 380 and 480 are interfaces for communicating with other devices (including, for example, one or more of a USB interface, a wired local area network (LAN) interface, and a wireless interface of IEEE802.11). The communication interfaces 380 and 480 are connected to the network IT. In the present embodiment, the communication interface 380 of the service server 300 and the communication interface 480 of the management server 400 are connected by an internal network SN inside the server system 200 without passing through the network IT outside the server system 200. Communication between the service server 300 and the management server 400 is performed via the internal network SN.

The service server 300 performs processing for providing a service that uses a device. The MFP 100 is an example of a device used for a service. The service may be various services. In the present embodiment, the service server 300 provides a remote printing service. Specifically, the service server 300 receives a print request including data of a target image from a terminal device (not shown) (for example, a smartphone or a personal computer) via the network IT. The service server 300 causes a device (for example, the MFP 100) to print the target image via the network IT. The user may receive the service by registering the device in the service server 300 in advance.

The nonvolatile memory 330 of the service server 300 stores a program PG3 and a service database D3. The program PG3 is uploaded to the service server 300 by a service provider. Hereinafter, a portion of the storage area formed by the nonvolatile memory 330, which stores the service database D3, is referred to as a first storage area SA1.

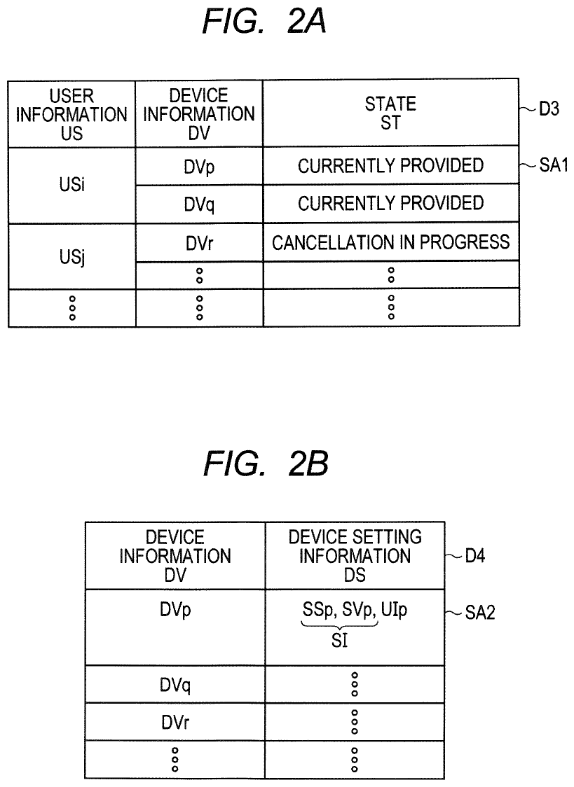

FIG. 2A is a diagram representing an example of the service database D3. In the present embodiment, the service database D3 represents a correspondence among user information US, device information DV, and state ST. The user information US is information on a user associated with a service. The user information US includes, for example, a user identifier. The device information DV is information on a device used for a service. The device information DV includes, for example, a device identifier. In the present embodiment, the data representing the device identifier is stored in advance in a memory of the device (for example, the nonvolatile memory 130 of the MFP 100) when the device is manufactured. The state ST indicates the state of the service. In the present embodiment, the state ST is selected from a plurality of states including “currently provided” indicating that the service is being provided and “canceling” indicating that the cancellation of the service is in progress.

Although not shown, the user registers a device such as the MFP 100 in the service server 300 in advance in order to receive the service. In a registration process, the server system 200 (for example, the service server 300 or the management server 400) assigns a user identifier to the user. The service server 300 then registers, in the service database D3, a correspondence among the user information US including the user identifiers, the device information DV including the device identifier, and the state ST indicating “currently provided”. The user information US may further include various types of information related to the user, such as a payment method of the cost of the service. The device information DV may further include various information related to the device, such as a model name of the device.

In the registration process, the MFP 100 (FIG. 1) stores various information used for the service in the nonvolatile memory 130. In the present embodiment, the MFP 100 stores the communication information SSp and the service information SVp in the nonvolatile memory 130.

The communication information SSp is information used for communication for a service. In the present embodiment, the communication information SSp includes access information for accessing the service server 300 and access information for accessing the management server 400. The access information may include, for example, a Uniform Resource Locator (URL). Hereinafter, the URL of the management server 400 is referred to as a management URL. The management URL is used to transmit various types of information related to the service to the management server 400. The scheme of the management URL may be, for example, http. The communication information SSp may be notified to the MFP 100 by the server system 200 (for example, the service server 300 or the management server 400) in the registration process. The management URL may be different for each device used for the service. For example, the management URL may include a different path for each device. Alternatively, the management URL may be common to a plurality of devices.

The service information SVp is information related to a service. The service information SVp may include, for example, the user information US associated with the MFP 100.

The communication information SSp and the service information SVp are examples of setting information indicating settings used for a service. Hereinafter, the information SSp and SVp is also collectively referred to as service setting information SI or simply as setting information SI.

The device information DVp is the device information DV associated with the MFP 100. In the present embodiment, the device information DVp is stored in the nonvolatile memory 130 when the MFP 100 is manufactured.

The user setting information UIp represents the settings of the MFP 100 determined by the user. The user setting information UIp may include, for example, a shortcut. The shortcut is a function that invokes and performs a set of frequently used settings, such as copy settings (quality and contrast, for example) and scan settings (resolution and scan size, for example).

In the example of FIG. 2A, two device information DVp and DVq are associated with user information USi. The states ST of these two device information DVp and DVq are “currently provided”. One device information DVr is associated with user information USj. The state ST of the device information DVr is “cancellation in progress”. The service server 300 provides a service using a device associated with the state ST indicating “currently provided”. The service server 300 may perform a process different from the provision of the service for the device associated with the state ST indicating “cancellation in progress”. For example, the service server 300 may stop providing the service. The service server 300 may return an error to a request for the service.

The management server 400 performs various processes related to a service. In the present embodiment, the process performed by the management server 400 includes a process for resetting a device associated with a service. As described below, the user may start a reset process by inputting a reset instruction to the device. As the reset process in the device progresses, the device information DV is deleted from the service database D3 (FIG. 2A). As a result, the device is excluded from the service target. That is, the service is cancelled.

The nonvolatile memory 430 of the management server 400 stores a program PG4 and a management database D4. The program PG4 is uploaded to the management server 400 by a service provider. Hereinafter, a portion of the storage area formed by the nonvolatile memory 430, which stores the management database D4, is referred to as a second storage area SA2.

FIG. 2B is a diagram illustrating an example of the management database D4. In this embodiment, the management database D4 indicates a correspondence between the device information DV and the device setting information DS. The device information DV is the same as the device information DV of FIG. 2A. The device setting information DS is information indicating the settings of the device, and includes service setting information used for the service. In the example of FIG. 2B, three device information DVp, DVq, and DVr are registered. The device setting information DS associated with the device information DVp indicating the MFP 100 includes the setting information SI (that is, the communication information SSp and the service information SVp) and the user setting information UIp.

In the present embodiment, the information SSp, SVp, UIp stored in the nonvolatile memory 130 of the MFP 100 is deleted by the reset process in the MFP 100 (FIG. 1). When a malfunction (failure) occurs during the reset process, a part of the information to be deleted may remain in the device without being deleted. Incomplete deletion of information may prevent a new use of the device. In this embodiment, the information of the device is backed up in the management database D4. In a case where a malfunction occurs in the reset process, the information of the device is restored using the information of the management database D4 (details will be described later).

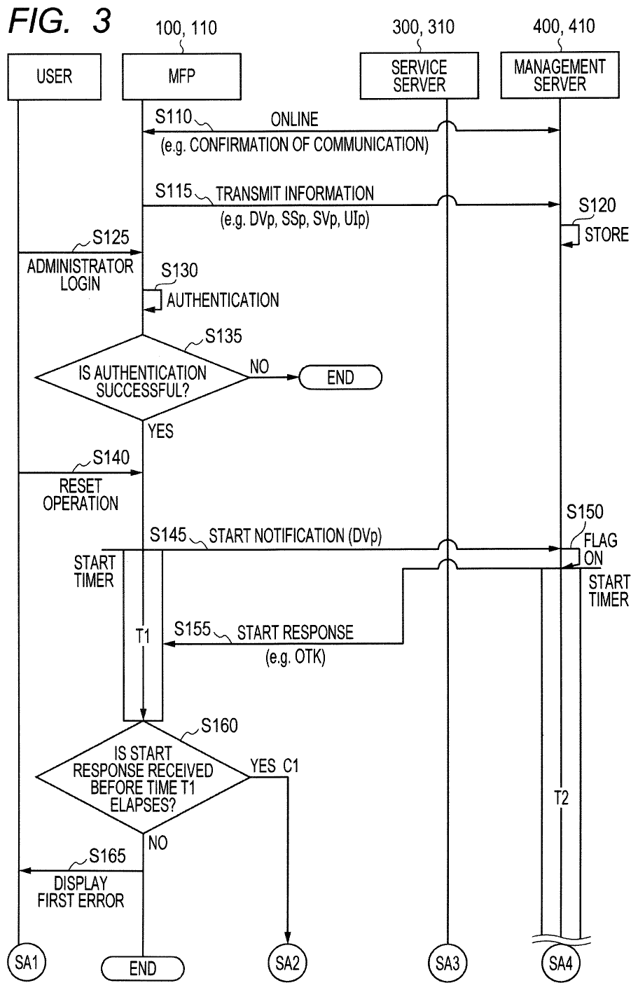

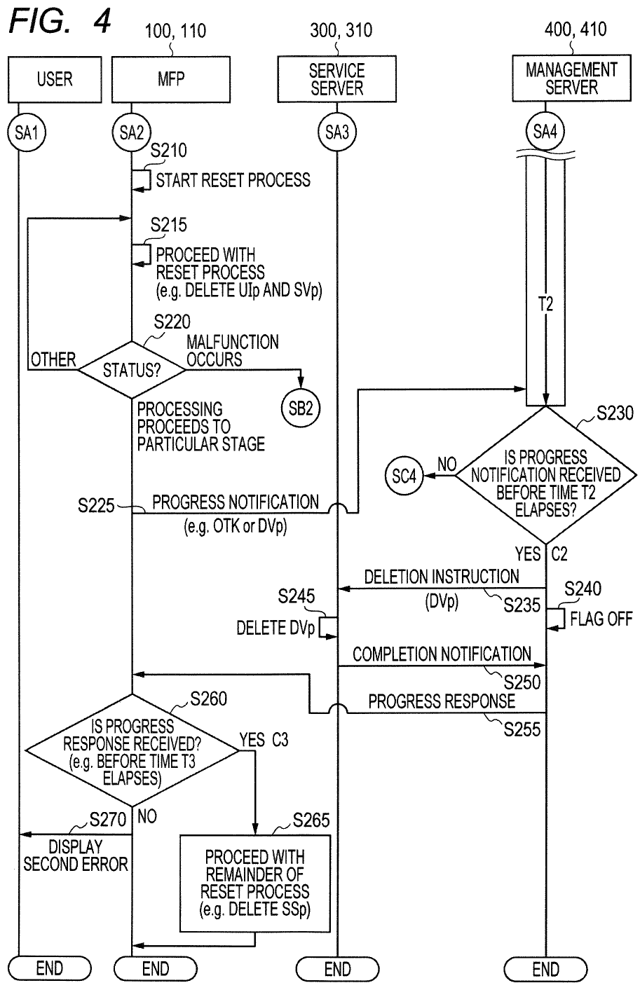

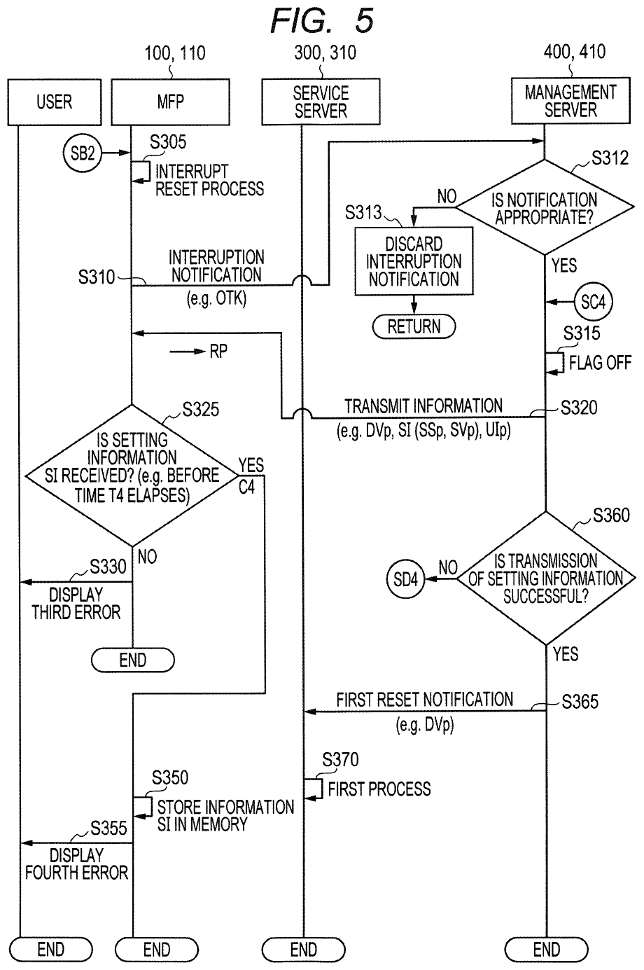

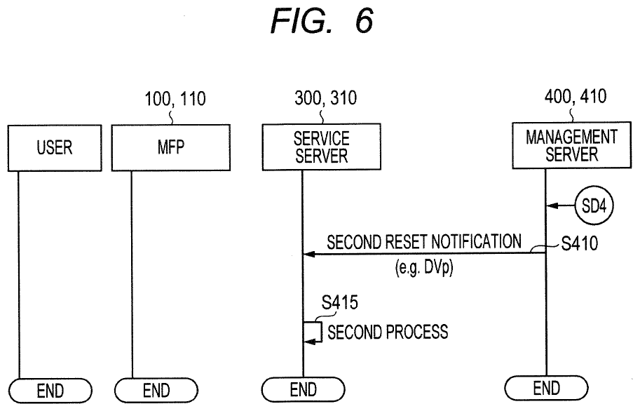

FIGS. 3 to 6 are sequence diagrams illustrating an example of the reset process by the MFP 100 and a server process by the server system 200. FIG. 4 shows a continuation of FIG. 3, FIG. 5 shows a continuation of FIG. 4, and FIG. 6 shows a continuation of FIG. 5. The processors 110, 310, and 410 of the MFP 100, the service server 300, and the management server 400 perform corresponding processes in accordance with the programs PG1, PG3, and PG4, respectively. Hereinafter, the processor 110 of the MFP 100 is referred to as a device processor 110, the processor 310 of the service server 300 is referred to as a service processor 310, and the processor 410 of the management server 400 is referred to as a management processor 410.

In S110, the device processor 110 confirms that the device processor 110 is ready to communicate with the management server 400. For example, the device processor 110 refers to the communication information SSp (FIG. 1) to acquire the management URL, accesses the management URL, and acquires a response (for example, an affirmative response) from the management server 400. This enables the MFP 100 to confirm that the MFP 100 is ready to communicate with the management server 400. Hereinafter, the device processor 110 transmits information to the management server 400 through the management URL. The device processor 110 may perform S110 at various timings. In the present embodiment, it is assumed that S110 is included in the registration process.

In S115, the device processor 110 transmits information stored in the MFP 100 to the management server 400. The information to be transmitted includes information to be deleted by the reset process. In this embodiment, the device processor 110 transmits the data of the information DVp, SSp, SVp, and UIp to the management server 400. In S120, the management processor 410 registers (stores) the received information DVp, SSp, SVp, and UIp in the management database D4 (FIG. 2B). The device processor 110 may perform S115 at various timings. In the present embodiment, it is assumed that S115 is included in the registration process.

In S125, the user logs in to the MFP 100 as an administrator. In S130, the device processor 110 authenticates the login. The authentication method may be various methods. In the present embodiment, the administrator of the MFP 100 registers a password for the administrator in the MFP 100 in advance. The device processor 110 stores authentication data of the password determined by the administrator (for example, a hash value of the password) in the nonvolatile memory 130 (not shown). In S125, the user inputs the administrator password by operating the operation interface 150. In S130, the device processor 110 authenticates the entered password. In a case where the authentication fails (S135: NO), the device processor 110 ends the processing without starting the reset process (thereafter, the device processor 110 waits for an input of a new instruction such as login). In this way, the device processor 110 does not accept an instruction to start reset when the authentication fails.

In a case where the authentication succeeds (S135: YES), the device processor 110 accepts an instruction of the reset process (reset operation). Here, it is assumed that the user inputs an instruction to start reset by operating the operation interface 150 in S140. In S145, the device processor 110 transmits a start notification of the reset process to the management server 400. The start notification includes data of information for identifying the device to be reset (in the present embodiment, the device information DVp). The device processor 110 also starts a timer. The device processor 110 accepts a start response (described later) until a first waiting time T1 elapses from the transmission of the start notification.

The management processor 410 performs S150 and S155 in response to the start notification. In S150, the management processor 410 sets a processing flag to ON, indicating that the reset process associated with the device information DV (the device information DVp in this case) contained in the start notification is in progress. In S155, the management processor 410 transmits a start response, which is a response to the start notification, to the device (here, the MFP 100) that is the transmission source of the start notification. In the present embodiment, the start response includes data of a one-time secret key OTK used when the reset process is interrupted. The management processor 410 generates the one-time secret key OTK by using a random number for each start response. The management processor 410 also starts a timer. The management processor 410 accepts a progress notification (described later) until a second waiting time T2 elapses from the transmission of the start response.

In S160, the device processor 110 determines whether the start response is received by the MFP 100 before the first waiting time T1 elapses. In some cases, the start response is not received before the first waiting time T1 elapses due to various causes such as a malfunction of a communication path between the MFP 100 and the management server 400 or a malfunction of the server system 200. The first waiting time T1 is experimentally determined in advance such that the start response is received before the first waiting time T1 elapses from the transmission of the start notification (S145) in a case where no malfunction occurs, and a time longer than the first waiting time T1 elapses without the start response being received from the transmission of the start notification in a case where a malfunction occurs. The first waiting time T1 may be, for example, 30 seconds or more and 2 minutes or less (more specifically, for example, 1 minute).

In a case where the start response is not received before the first waiting time T1 elapses (S160: NO), in S165 the device processor 110 displays, on the display 140, a first error indicating that the start response is not received before the first waiting time T1 elapses. The first error may include, for example, a message indicating that the start response is not received before the first waiting time T1 elapses. The user recognizes that the start response is not received before the first waiting time T1 elapses by observing the displayed first error. The user may proceed with processing for solving the communication malfunction, such as reviewing the communication settings of the MFP 100 or reviewing the communication settings of a relay device (for example, a router) (not shown) to which the MFP 100 is connected. After S165, the device processor 110 ends the processing without starting the reset process. After that, the device processor 110 waits for an input of a new instruction such as login.

In a case where the start response is received before the first waiting time T1 elapses (S160: YES), the device processor 110 starts the reset process in S210 (FIG. 4). In this embodiment, the reset process includes a process of deleting the information SSp, SVp, and UIp stored in the nonvolatile memory 130 in a particular order. The order of the information (here, the communication information SSp) used for communication with the management server 400 is set to the last. Hereinafter, it is assumed that the deletion is performed in the order of the user setting information UIp, the service information SVp, and the communication information SSp.

In S215, the device processor 110 proceeds with the reset process. In this embodiment, the device processor 110 proceeds to delete information based on the deletion order.

In S220, the device processor 110 branches the processing depending on the status of the reset process. In a case where a malfunction occurs in the reset process, the device processor 110 advances to S305 (FIG. 5). In the reset process, various malfunctions may occur. For example, the MFP 100 may be restarted in the middle of the reset process (for example, the MFP 100 is powered off and then powered on). In addition, the reset process may be interrupted by an operation of the operation interface 150 by the user during the reset process. The processing in the case where a malfunction occurs in the reset process will be described later.

In a case where the reset process has progressed to a particular stage, the device processor 110 advances to S225 (described in more detail below). In the present embodiment, the particular stage is a stage in which the user setting information UIp and the service information SVp are deleted.

In a case where the status of the reset process is another status different from the above two statuses, that is, in a case where no malfunction occurs in the reset process and the reset process has not progressed to the particular stage, the device processor 110 returns to S215 and proceeds with the reset process. In this way, in a case where no malfunction occurs in the reset process, the device processor 110 repeats S215 to advance the reset process to the particular stage. In the present embodiment, the device processor 110 deletes the user setting information UIp and the service information SVp from the nonvolatile memory 130.

In a case where the reset process has progressed to the particular stage, in S225, the device processor 110 transmits a progress notification to the management server 400, the progress notification being a notification indicating that the reset process has progressed to the particular stage. The progress notification includes data of information for identifying the device to be reset (for example, the one-time secret key OTK or the device information DVp).

In S230, the management processor 410 determines whether the progress notification is received by the management server 400 before a second waiting time T2 elapses from the transmission of the start response (FIG. 3: S155). The progress notification used for the determination is a progress notification including information for identifying the device associated with the start response (S155), that is, the device associated with the start notification (S145). The progress notification may not be received before the second waiting time T2 elapses due to various causes such as a malfunction in the reset process in the MFP 100 and a malfunction in the communication path between the MFP 100 and the management server 400. The second waiting time T2 is experimentally determined in advance such that the progress notification is received before the second waiting time T2 elapses from the transmission of the start response (S155) in a case where no malfunction occurs, and a time longer than the second waiting time T2 may elapse without the progress notification being received from the transmission of the start response in a case where a malfunction occurs. The second waiting time T2 may be, for example, 30 seconds or more and 2 minutes or less (more specifically, for example, 1 minute).

In a case where the progress notification is received before the second waiting time T2 elapses (S230: YES), the management processor 410 transmits a deletion instruction to the service server 300 in S235. This instruction includes data of the device information DV (here, the device information DVp) indicating the device associated with the progress notification. In S240, the management processor 410 sets a processing flag associated with the device associated with the progress notification to OFF.

In S245, the service processor 310 deletes the device information DV and the state ST of the device associated with the deletion instruction from the service database D3 (FIG. 2A) in response to the deletion instruction (S235). In S245 of FIG. 4, the service processor 310 deletes the device information DVp associated with the deletion instruction (S235) and the state ST associated with the device information DVp from the service database D3.

The user information US associated with the device information DV to be deleted may be associated with the device information DV of another device. In this case, the service processor 310 maintains the information of the other device without deleting the information. For example, in the example of FIG. 2A, the device information DVq of another device is associated with the user information USi associated with the device information DVp to be deleted. The device information DVq is not deleted but maintained. The user information US is not deleted but maintained. The user information US may be reused by a future registration process. In some case, the device information DV of another device is not associated with the user information US associated with the device information DV to be deleted. In this case, the service processor 310 may delete the user information US associated with the device information DV to be deleted.

In S250, the service processor 310 transmits a completion notification of the deletion to the management server 400. In S255, the management processor 410 transmits a progress response, which is a response to the progress notification (S225), to the device (here, the MFP 100) that is the transmission source of the progress notification.

In S260, the device processor 110 determines whether the progress response is received by the MFP 100. The progress response may not be received due to various causes such as a malfunction of the communication path between the MFP 100 and the management server 400, a malfunction of the server system 200, for example. The device processor 110 may limit the waiting time from the transmission of the progress notification (S225) to the reception of the progress response. In the present embodiment, the device processor 110 determines that the progress response is received in a case where the progress response is received before a third waiting time T3 elapses from the transmission of the progress notification. In a case where the progress response is not received before the third waiting time T3 elapses, the device processor 110 determines that the progress notification is not received. The third waiting time T3 may be experimentally determined in advance such that the progress response is received before the third waiting time T3 elapses from the transmission of the progress notification (S225) in a case where no malfunction occurs, and a time longer than the third waiting time T3 may elapse without the progress response being received from the transmission of the progress notification in a case where a malfunction occurs. The third waiting time T3 may be, for example, 30 seconds or more and 2 minutes or less (more specifically, for example, 1 minute).

In a case where the progress response is received before the third waiting time T3 elapses (S260: YES), the device processor 110 proceeds with the remainder of the reset process in S265. In S265 of FIG. 4, the remainder process includes deletion of the communication information SSp from the nonvolatile memory 130. The reset process is completed by the completion of S265.

When the progress response is not received before the third waiting time T3 elapses (S260: NO), in S270 the device processor 110 displays, on the display 140, a second error indicating that the reset process is not completed and the progress response is not received. The second error may include, for example, a message indicating that the reset process is not completed and that the progress response is not received. By observing the displayed second error, the user recognizes that the reset process is not completed and that there is a possibility that the device information DVp is not deleted from the service database D3. The user may proceed with a process for solving the malfunction of the reset process, such as inquiring of the service provider about the second error. After S270, the reset process ends.

In response to determining in S220 (FIG. 4) that a malfunction in the reset process has occurred, the device processor 110 advances to S305 (FIG. 5). In S305, the device processor 110 interrupts the reset process. In S310, the device processor 110 transmits an interruption notification indicating the interruption of the reset process to the management server 400. The interruption notification contains the one-time secret key OTK (FIG. 3: S155).

In S312, the management processor 410 determines whether the interruption notification is appropriate. S312 may be determined by various methods. In this embodiment, the management processor 410 determines that the interruption notification is appropriate when the interruption notification includes the same one-time secret key OTK as the one-time secret key OTK included in the start response (FIG. 3: S155). In a case where the interruption notification is not appropriate (S312: NO), the management processor 410 discards the interruption notification in S313. Then, the management processor 410 returns to the processing of waiting for a notification from the device such as the progress notification (FIG. 4: S225) and the interruption notification (FIG. 5: S310).

In a case where the interruption notification is appropriate (S312: YES), in S315, the management processor 410 sets the processing flag associated with the device associated with the interruption notification to OFF. As described above, the one-time secret key OTK included in the interruption notification is associated with the start response (FIG. 3: S155), and the start response is associated with the start notification (FIG. 3: S145). The device associated with the interruption notification is the device indicated by the device information (here, the device information DVp) included in the start notification associated with the interruption notification.

In S320, the management processor 410 transmits a response to the interruption notification (S310) to the device from which the interruption notification was sent. The response includes data of information of the device associated with the interruption notification. In this embodiment, the management processor 410 references the management database D4 (FIG. 2B) and acquires the device setting information DS associated with the device information DV of the device associated with the interruption notification. In S320 of FIG. 5, the management processor 410 acquires the information SSp, SVp, and UIp (including the setting information SI) associated with the device information DVp. The management processor 410 transmits data representing the device information DVp and the acquired information SSp, SVp, and UIp to the device (here, the MFP 100) that is the transmission source of the interruption notification. In response to completing reception of the information, the communication interface 180 or the device processor 110 of the MFP 100 transmits a reception response RP indicating the completion of the reception of the information to the management server 400.

Here, a process performed by the MFP 100 after S320 will be described. The processing by the server system 200 will be described later. In S325, the device processor 110 determines whether the setting information SI is received by the MFP 100. The setting information SI may not be received due to various reasons such as a malfunction of the communication path between the MFP 100 and the management server 400, or a malfunction of the server system 200, for example. The device processor 110 may limit the waiting time from the transmission of the interruption notification (S310) to the reception of the setting information SI. In the present embodiment, the device processor 110 determines that the setting information SI is received in a case where the setting information SI is received before a fourth waiting time T4 elapses from the transmission of the interruption notification. In a case where the setting information SI is not received before the fourth waiting time T4 elapses, the device processor 110 determines that the setting information SI is not received. The fourth waiting time T4 may be experimentally determined in advance so that the setting information SI is received before the fourth waiting time T4 elapses from the transmission of the interruption notification (S310) in a case where no malfunction occurs, and a time longer than the fourth waiting time T4 may elapse without the setting information SI being received from the transmission of the interruption notification in a case where a malfunction occurs. The fourth waiting time T4 may be, for example, 30 seconds or more and 2 minutes or less (more specifically, for example, 1 minute).

In a case where the setting information SI is not received before the fourth waiting time T4 elapses (S325: NO), the device processor 110 displays a third error on the display 140 in S330. The third error may include, for example, a message indicating that the setting information SI is not received. The user recognizes that there is a possibility that a malfunction of the reset process has occurred by observing the displayed third error. The user may proceed with the process for solving the malfunction of the reset process, such as inquiring of the service provider about the third error. After S330, the reset process ends.

In a case where the setting information SI is received before the fourth waiting time T4 elapses (S325: YES), in S350 the device processor 110 stores the received information SSp, SVp, and UIp (including the setting information SI) in the nonvolatile memory 130. As a result, the settings of the MFP 100 are restored to the settings before the start of the reset process.

In S355, the device processor 110 displays a fourth error on the display 140. The fourth error may include, for example, a message indicating that the settings of the MFP 100 have been restored to the settings before the start of the reset process. The user recognizes the restoration of the settings of the MFP 100 by observing the displayed fourth error. The user may proceed with the process for solving the malfunction of the reset process, such as inputting a reset instruction again or inquiring of the service provider about the fourth error. After S355, the reset process ends.

Next, processing by the server system 200 after S320 (FIG. 5) will be described. In S360, the management processor 410 determines whether the transmission of the setting information is successful. S360 may be determined by various methods. In the present embodiment, the management processor 410 determines that the transmission of the setting information is successful when the reception response RP from the MFP 100 is received by the management server 400 in S320.

In a case where the transmission of the setting information is successful (S360: YES), in S365, the management processor 410 transmits a first reset notification to the service server 300. The first reset notification indicates that the reset process has been started, that the reset process may have a malfunction, and that the settings of the device have been restored. The first reset notification includes data of the device information DV (here, the device information DVp) of the target of the interrupted reset process.

In S370, the service processor 310 performs the first process in response to the first reset notification. After S370, the server process ends. The first process may be various processes suitable for the service when the reset process is started and the reset process has a malfunction. The first reset notification indicates that the settings of the device have been restored. Thus, the service processor 310 may provide a service associated with the device information DVp of the target of the reset process, in a similar manner to before the start of the reset process. For example, the first process may include a process of setting the state ST associated with the device information DVp in the service database D3 (FIG. 2A) to “currently provided”. Thereafter, the user may input a reset instruction to the MFP 100, whereby the reset process may be performed again.

The first reset notification also indicates that the administrator of the device desires a reset process. In a case where the reset process is completed normally, a new registration process of the device may be performed thereafter. Thus, the first process may include a process of allowing new registration of the device information DVp of the target of the reset process. For example, the service processor 310 may set the state ST associated with the device information DVp in the service database D3 to “currently provided and re-registerable”. When the state ST indicates “re-registerable”, in the new registration process of the device information DVp, the service processor 310 may delete old information associated with the device information DVp from the service database D3, and register new information associated with the device information DVp in the service database D3. In a case where the state ST does not indicate “re-registerable”, the service processor 310 may reject a new registration process of the device information DVp.

In a case where the transmission of the setting information is not successful (S360: NO), in S410 the management processor 410 transmits a second reset notification to the service server 300 (FIG. 6). The second reset notification indicates that the reset process has been started, that the reset process may have a malfunction, and that the information stored in the device has been partially deleted. The second reset notification includes data of the device information DV (here, the device information DVp) of the target of the interrupted reset process.

In S415, the service processor 310 performs the second process in response to the second reset notification. After S415, the server processing ends. The second process may be various processes suitable for the service when the reset process is started and the reset process has a malfunction. The second reset notification indicates that a part of the settings of the device has been deleted. That is, the device may not have some of the information used for the service. Thus, the second process may include a process of stopping providing the service associated with the device information DVp that is the target of the reset process. For example, the service processor 310 may set the state ST associated with the device information DVp in the service database D3 (FIG. 2A) to “cancellation in progress”. As a result, the service server 300 stops providing the service associated with the device information DVp.

The second reset notification also indicates that the administrator of the device desires a reset process. Thus, the second process may include a process of allowing new registration of the device information DVp of the target of the reset process. For example, the service processor 310 may set the state ST associated with the device information DVp in the service database D3 to “cancellation in progress and re-registration possible”. Alternatively, the second process may include a process of deleting the information associated with the device information DVp from the service database D3. In this case, the device information DVp may be registered in the service database D3 by a new registration process. In the new registration process, the device (here, the MFP 100) associated with the device information DVp may delete, from the nonvolatile memory 130, the information that has remained without being deleted in the interrupted reset process.

Next, a case where the progress notification is not received before the second waiting time T2 elapses in S230 of FIG. 4 will be described. In this case (S230: NO), the management processor 410 advances to S315 in FIG. 5. As described above, in a case where the progress notification is not received before the second waiting time T2 elapses, there is a possibility that a malfunction of the reset process has occurred in the MFP 100. The management processor 410 performs the same process as the process performed when the interruption notification (S310) from the MFP 100 is received by the management server 400. For example, the management processor 410 sets the processing flag to OFF (S315), and transmits information including the setting information SI to the MFP 100 (S320).

For example, it is assumed that the transmission of the progress notification (S225 in FIG. 4) is delayed due to a malfunction of the MFP 100. In this case, the MFP 100 receives the setting information SI (S320) although the interruption notification (FIG. 5: S310) is not transmitted. In this case, in S325, the device processor 110 determines that the setting information SI is received regardless of the interruption notification (S310) (S325: YES). The device processor 110 prioritizes processing of the received setting information SI over deleting information from the nonvolatile memory 130. In other words, the device processor 110 performs processing of the received setting information SI, instead of deleting information from the nonvolatile memory 130. Specifically, the device processor 110 performs S350 and S355. After S355, the reset process ends.

For example, it is assumed that no malfunction occurs in the MFP 100 and a malfunction occurs in the communication path between the MFP 100 and the management server 400. In this case, the MFP 100 cannot receive the start response (FIG. 3: S155) or the progress response (FIG. 4: S255). Thus, the device processor 110 displays the first error (FIG. 3: S165) or the second error (FIG. 4: S270). Then, the reset process ends.

As described above, in the present embodiment, the communication system 1000 (FIG. 1) includes the server system 200 and the MFP 100. The MFP 100 is an example of a device used for a service. The server system 200 includes the management processor 410 and the first storage area SA1. The management processor 410 is an example of a server controller that controls the server system 200 (hereinafter, the management processor 410 is also referred to as a server controller 410). As shown in FIG. 2A, the first storage area SA1 is configured to store the device information DV (for example, the device information DVp) indicating the device and the user information US (for example, the user information USi) indicating the user associated with the service in association with each other.

The MFP 100 includes the device processor 110 and the nonvolatile memory 130. The device processor 110 is an example of a device controller that controls the MFP 100 (hereinafter, the device processor 110 is also referred to as a device controller 110). The nonvolatile memory 130 is configured to store information including the device information DVp and the setting information SI. The setting information SI includes communication information SSp and service information SVp. The communication information SSp and the service information SVp are examples of setting information indicating settings used for a service.

The device controller 110 and the server controller 410 perform the following processing. In S145 (FIG. 3), the device controller 110 transmits the start notification, which is a notification including the device information DVp, to the server system 200 (in the present embodiment, the management server 400) in response to the reset instruction (S140) by the user of the MFP 100. In S155, when the start notification is received by the server system 200 (in the present embodiment, the management server 400), the server controller 410 transmits the start response, which is a response to the start notification, to the MFP 100.

As described in S160 (FIG. 3), the device controller 110 determines whether the start response is received by the MFP 100 before the first waiting time T1 elapses. In a case C1 where the determination result of S160 is YES, the device controller 110 starts the reset process in S210 (FIG. 4). The reset process includes a process (S215, S265) of deleting the setting information SI (in the present embodiment, the information SSp, SVp) from the nonvolatile memory 130 of the MFP 100. As described above, the case C1 where the determination result of S160 is YES is an example of a first particular case where the start response is received by the MFP 100 and the reset process is started. In the following, the case C1 will also be referred to as the first particular case C1.

As described in S220 and S225 (FIG. 4), the device controller 110 transmits the progress notification to the server system 200 (the management server 400 in the present embodiment) in response to the reset process progressing to the particular stage. The progress notification indicates the progress of the reset process to the particular stage.

As described in S230 (FIG. 4), the server controller 410 determines whether the progress notification is received by the management server 400 before the second waiting time T2 elapses. In a case C2 where the determination result of S230 is YES, the server controller 410 performs S235 and S255. In S235, the server controller 410 transmits the deletion instruction to the service server 300. The service processor 310 deletes the device information DVp from the service database D3 (that is, the first storage area SA1) in response to the deletion instruction. As described above, the transmission (S235) of the deletion instruction is an example of a process for deleting the device information DVp from the service database D3 (that is, from the first storage area SA1). In S255, the server controller 410 transmits the progress response, which is a response to the progress notification (S225), to the MFP 100. As described above, the case C2 where the determination result of S230 is YES is an example of a second particular case where the progress notification is received by the server system 200 (in the present embodiment, the management server 400), and the process (S235) for deleting the device information DVp from the first storage area SA1 and the process (S255) for transmitting the progress response to the MFP 100 are performed. In the following, the case C2 will also be referred to as the second particular case C2.

As described in S260 (FIG. 4), the device controller 110 determines whether the progress response is received before the third waiting time T3 elapses. In a case C3 where the determination result of S260 is YES, the device controller 110 performs the remainder of the reset process in S265. As described above, the case C3 where the determination result of S260 is YES is an example of a third particular case where the progress response is received by the MFP 100 and the remainder of the reset process is performed. In the following, the case C3 is also referred to as the third particular case C3.

According to the above configuration, the device controller 110 and the server controller 410 use the start notification, the start response, the progress notification, and the progress response to proceed with the deletion of the device information DVp from the first storage area SA1 of the server system 200 and the reset process including the process of deleting the setting information SI from the nonvolatile memory 130 of the MFP 100. Thus, the possibility of occurrence of information inconsistency (mismatch) between the MFP 100 and the server system 200 is reduced.

In the present embodiment, the device controller 110 performs authentication of the user of the MFP 100 in S125 and S130 (FIG. 3). In S135 and S140, the device controller 110 accepts the reset instruction when the device controller 110 successfully performs authentication (S135: YES). Thus, the device controller 110 reduces the possibility that the reset process is erroneously performed.

In the present embodiment, in a case where the start response (S155) is not received by the MFP 100 (S160: NO) before the first waiting time T1 elapses from the transmission of the start notification (FIG. 3: S145), the device controller 110 does not start the reset process. In the first particular case C1 where the start response (S155) is received by the MFP 100 before the first waiting time T1 elapses from the transmission (S145) of the start notification (S160: YES), the device controller 110 starts the reset process (FIG. 4: S210). Thus, in a case where the communication path between the MFP 100 and the server system 200 or the server system 200 has a malfunction, the device controller 110 reduces the possibility that the reset process is proceeded without cooperating with the server system 200.

In the present embodiment, the MFP 100 (FIG. 1) includes the display 140. As described in S260 and S270 (FIG. 4), in a case where the progress response is not received by the device (S260: NO), the device controller 110 displays the second error on the display 140 (S270). The second error indicates that the reset process is not completed. By observing the second error, the user recognizes that the reset process is not completed (and thus, a possibility of information inconsistency between the MFP 100 and the server system 200).

In this embodiment, the server system 200 (FIG. 1) includes the management server 400 having the server controller 410 and the service server 300 having the first storage area SA1. The device controller 110 transmits the start notification (FIG. 3: S145) and the progress notification (FIG. 4: S225) to the management server 400. In the second particular case C2 (FIG. 4: S230: YES) where the progress notification is received by the management server 400, the server controller 410 transmits an instruction to delete the device information DVp from the first storage area SA1 of the service server 300 to the service server 300 (S235). In a case where the progress notification is not received by the management server 400 (FIG. 4: S230: NO) after the transmission of the start response (FIG. 3: S155), the server controller 410 transmits the first reset notification (FIG. 5: S365) or the second reset notification (FIG. 6: S410) to the service server 300. As described above, the first reset notification and the second reset notification indicate the start of the reset process.

According to this configuration, in the second particular case C2, the server controller 410 causes the service server 300 to delete the device information DVp. Further, in a case where the progress notification is not received by the management server 400 after the transmission of the start response (S230: NO), the server controller 410 transmits the notification indicating the start of the reset process to the service server (S365 or S410), and thus the server controller 410 causes the service server 300 to perform a process different from the deletion of the device information DVp. For example, the service server 300 may perform a process of allowing new registration of the device information DVp (that is, newly storing the device information DVp in the first storage area SA1) in response to the notification indicating the start of the reset process.

In the present embodiment, the server system 200 (FIG. 1) further includes the second storage area SA2 (FIG. 2B) configured to store the device information DVp and the setting information SI in association with each other. In a case where a malfunction occurs in the reset process after the start of the reset process (FIG. 4: S220), the device controller 110 interrupts the reset process (FIG. 5: S305), and transmits the interruption notification indicating the interruption of the reset process to the server system 200 (S310). In a case where the server system 200 receives the interruption notification, the server controller 410 transmits the setting information SI to the device (S320). In S325, the device controller 110 determines whether the setting information SI is received by the MFP 100 before the fourth waiting time T4 elapses. In a case where the determination result of S325 (FIG. 5) is YES, the device controller 110 stores the setting information SI in the memory 115 of the MFP 100 (S350). According to this configuration, the possibility that the setting information SI in the MFP 100 is partially lost due to the interruption of the reset process is reduced. A case C4 where the determination result of S325 is YES is an example of a fourth particular case where the setting information SI is received by the MFP 100 and the setting information SI is stored in the nonvolatile memory 130 of the MFP 100. In the following, the case C4 will be referred to as the fourth particular case C4.

In the present embodiment, the server system 200 (FIG. 1) further includes the second storage area SA2 (FIG. 2B) configured to store the device information DVp and the setting information SI in association with each other. In a case where the progress notification (FIG. 4: S225) is not received by the server system 200 (S230: NO) after the transmission of the start response (FIG. 3: S155), the server controller 410 transmits the setting information SI to the device (FIG. 5: S320). As described above, in a case where the setting information SI is received by the MFP 100 (S325: YES), the device controller 110 stores the setting information SI in the nonvolatile memory 130 of the MFP 100 (S350). According to this configuration, the possibility that the setting information SI in the MFP 100 is partially lost is reduced.

In the present embodiment, as described in S230 of FIG. 4, the second particular case C2 is a case where the progress notification is received by the server system 200 before the second waiting time T2 elapses from the transmission of the start response. Thus, the server controller 410 performs the process for deleting the device information DVp from the first storage area SA1 in the second particular case C2 where the progress notification is appropriately received.

In the present embodiment, as described in S260 of FIG. 4, the third particular case C3 is a case where the progress response is received by the MFP 100 before the third waiting time T3 elapses from the transmission of the progress notification. Thus, the device controller 110 performs the remainder of the reset process in the third particular case C3 where the progress response is appropriately received.

In the present embodiment, as described in S312 and S320 (FIG. 5), the server controller 410 transmits the information of the device to the device that is the transmission source of the interruption notification in a case where the interruption notification is appropriate. Thus, the possibility that the information of the device is erroneously transmitted to another device is reduced. The method of determining whether the interruption notification is appropriate is not limited to the method of using the one-time secret key OTK included in the start response (FIG. 3: S155), and may be various methods. For example, the one-time secret key OTK may be omitted, and a secret key associated with the device information DVp in advance may be used.

In the present embodiment, the management server 400 (FIG. 1) has the following configuration. The management server 400 is configured to communicate with each of the service server 300 and the MFP 100. The MFP 100 is an example of a device used for a service. The management server 400 includes the server controller 410. The service server 300 includes the first storage area SA1 (FIG. 2A). The first storage area SA1 is configured to store the device information DV (for example, the device information DVp) indicating the device and the user information US (for example, the user information USi) indicating the user associated with the service in association with each other. The MFP 100 includes the nonvolatile memory 130 configured to store the device information DVp and the setting information SI indicating settings used for a service. In the particular case C2 where the progress notification from the MFP 100 is received by the management server 400 (FIG. 4: S230: YES), the server controller 410 transmits an instruction to delete the device information DVp from the first storage area SA1 of the service server 300 to the service server 300 (S235). As described in S220 of FIG. 4, the progress notification (S225) is a notification transmitted by the MFP 100 in response to the progress of the reset process to the particular stage. The reset process includes a process (S215, S265) of deleting the setting information SI (in the present embodiment, the information SSp, SVp) from the nonvolatile memory 130 of the MFP 100. As described above, the server controller 410 transmits the instruction to delete the device information DVp to the service server 300 in the particular case C2 where the progress notification from the MFP 100 is received by the management server 400. Thus, the possibility of occurrence of information inconsistency between the MFP 100 and the service server 300 is reduced as compared with a case where the instruction to delete the device information DVp is transmitted in response to the start notification (FIG. 3: S145).

In the present embodiment, the MFP 100 (FIG. 1) has the following configuration. The MFP 100 is an example of a device used for a service, and is configured to communicate with the server system 200. The MFP 100 includes the device controller 110 and the nonvolatile memory 130. The nonvolatile memory 130 is configured to store the device information DVp indicating the device and the setting information SI indicating the setting used for the service. In S145 (FIG. 3), the device controller 110 transmits the start notification, which is a notification including the device information DVp, to the server system 200 (in the present embodiment, the management server 400) in response to the reset instruction (S140) by the user of the MFP 100.

As described in S160 (FIG. 3), in a case where the determination result of S160 is NO, the device controller 110 does not start the reset process, and in the first particular case C1 where the determination result of S160 is YES, the device controller 110 starts the reset process (FIG. 4: S210). In S160, the device controller 110 determines whether the start response (S155) is received by the MFP 100 before the first waiting time T1 elapses from the transmission of the start notification (FIG. 3: S145). The start response is a response from the server system 200 to the start notification (S145). The reset process includes the process (S215, S265) of deleting the setting information SI from the nonvolatile memory 130 of the MFP 100.

As described in S220 and S225 (FIG. 4), the device controller 110 transmits the progress notification to the server system 200 (the management server 400 in the present embodiment) in response to the reset process progressing to the particular stage. The progress notification indicates the progress of the reset process to the particular stage. As described in S260 (FIG. 4), in the case C3 where the determination result of S260 is YES, the device controller 110 performs S265. In S260, the device controller 110 determines whether the progress response is received during a period before the third waiting time T3 elapses from the transmission of the progress notification. In S265, the device controller 110 performs the remainder of the reset process. As described above, the case C3 where the determination result of S260 is YES is an example of the particular case where the progress response, which is a response from the server system 200 to the progress notification, is received by the MFP 100, and the remainder of the reset process is performed.

According to the above configuration, the device controller 110 proceeds with the reset process by using the start notification, the start response, the progress notification, and the progress response. Thus, the possibility that the information in the MFP 100 does not match the information in the server system 200 is reduced.

While the present disclosure has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the present disclosure, and not limiting the present disclosure. Various changes may be made without departing from the spirit and scope of the disclosure. Thus, the disclosure is intended to embrace all known or later developed alternatives, modifications, variations, improvements, and/or substantial equivalents. Some specific examples of potential alternatives, modifications, or variations in the described disclosure are provided below.

(1) The authentication method in S130 (FIG. 3) may be various methods. For example, the device controller 110 may perform user authentication by communicating with an authentication server (not shown). The user authentication may be authentication of a user associated with a service that uses the MFP 100. The user authentication may be performed by the service server 300. The user authentication for receiving the reset instruction may be omitted.

(2) The deletion order of the plurality of information deleted by the reset process may be various orders. For example, the deletion order may be the order of the information SVp, UIp, and SSp instead of the order of the information UIp, SVp, and SSp. The information (for example, the communication information SSp) used for communication with the server system 200 is deleted last. The information deleted by the reset process may be various types of information including setting information indicating a setting used for a service. For example, the user setting information UIp may not be deleted by the reset process. The device information DVp may be deleted by the reset process. In this case, the server system 200 (for example, the service server 300 or the management server 400) may assign a device identifier (and thus the device information DV) to the device in the registration process of the device.

In any case, the device controller 110 may transmit the progress notification (FIG. 4: S225) to the server system 200 in response to the reset process progressing to the particular stage. The particular stage may be various stages of the reset process. For example, the particular stage may be a stage in which one or more information that is a predetermined part of the plurality of information to be deleted are deleted.

(3) The first particular case where the reset process is started is not limited to the case C1 where the determination result of S160 (FIG. 3) is YES, and may be a case where a first particular condition is satisfied. The first particular condition may be various conditions including that the start response (S155) is received by the MFP 100. For example, as described in S160, the first particular condition may include a first waiting time condition indicating that the start response (S155) is received by the MFP 100 before the first waiting time T1 elapses from the transmission of the start notification (S145). The first particular condition may include another condition, for example, that a user instruction indicating the progress of the reset process is acquired. In any case, when the first particular condition includes the first waiting time condition, a case where the first particular condition is satisfied (that is, the first particular case) is a particular case where the start response is received by the MFP 100 before the first waiting time T1 elapses from the transmission of the start notification.

(4) The second particular case where S235 and S255 in FIG. 4 are performed is not limited to the case C2 where the determination result of S230 is YES, and may be a case where a second particular condition is satisfied. The second particular condition may be various conditions including that a progress notification is received by the server system 200. For example, as described in S230, the second particular condition may include a second waiting time condition indicating that the progress notification (FIG. 4: S225) is received by the server system 200 before the second waiting time T2 elapses from the transmission of the start response (FIG. 3: S155). The second particular condition may include another condition, for example, a condition that a user instruction indicating the progress of the reset process is acquired (the device controller 110 may provide the user instruction input to the MFP 100 to the management server 400). In any case, when the second particular condition includes the second waiting time condition, a case where the second particular condition is satisfied (that is, the second particular case) is a particular case where the progress notification is received by the server system 200 before the second waiting time T2 elapses from the transmission of the start response.

The server controller 410 may start the timer in response to receiving the start notification (S145). That is, in S230 (FIG. 4), the server controller 410 may determine whether the progress notification is received before a predetermined particular waiting time elapses from the reception of the start notification. Here, the server controller 410 may transmit the start response after a processing time has elapsed from the reception of the start notification. In this case, it can be said that, in S230, the server controller 410 determines whether the progress notification is received before the second waiting time T2 elapses from the transmission of the start response. Here, the second waiting time T2 is the remaining time obtained by subtracting the processing time from the particular waiting time. When the server controller 410 does not communicate with a device different from the management server 400 between the reception of the start notification (S145) and the transmission of the start response (S155), the processing time from the reception of the start notification to the transmission of the start response is substantially constant. That is, the second waiting time T2 is substantially constant.

(5) The third particular case where the remainder (FIG. 4: S265) of the reset process is performed is not limited to the case C3 where the determination result of S260 is YES, and may be a case where a third particular condition is satisfied. The third particular condition may be various conditions including that the progress response (S255) is received by the MFP 100. For example, as described in S260, the third particular condition may include a third waiting time condition indicating that the progress response (S255) is received by the MFP 100 before the third waiting time T3 elapses from the transmission of the progress notification (S225). The third particular condition may include another condition, for example, that a user instruction indicating the progress of the reset process is acquired. In any case, when the third particular condition includes the third waiting time condition, a case where the third particular condition is satisfied (that is, the third particular case) is a particular case where the progress response is received by the MFP 100 before the third waiting time T3 elapses from the transmission of the progress notification.

(6) The fourth particular case where the setting information SI is stored in the nonvolatile memory 130 of the MFP 100 after the transmission of the interruption notification (FIG. 5: S310) is not limited to the case C4 where the determination result of S325 is YES, and may be a case where a fourth particular condition is satisfied. The fourth particular condition may be various conditions including that the setting information SI (S320) is received by the MFP 100. For example, as described in S325, the fourth particular condition may include a fourth waiting time condition indicating that the setting information SI (S320) is received by the MFP 100 before the fourth waiting time T4 elapses from the transmission of the interruption notification (S310). The fourth particular condition may include another condition, for example, that a user instruction indicating storing the setting information SI is acquired. In any case, when the fourth particular condition includes the fourth waiting time condition, a case where the fourth particular condition is satisfied (that is, the fourth particular case) is a particular case where the setting information SI is received by the MFP 100 before the fourth waiting time T4 elapses from the transmission of the interruption notification.

(7) The process for deleting the device information DVp from the first storage area SA1 is not limited to the transmission of the deletion instruction (S235 (FIG. 4)), and may be various processes for deleting the device information DVp from the first storage area SA1. For example, the first storage area SA1 may be provided in the nonvolatile memory 430 of the management server 400. The server controller 410 may delete the device information DVp from the first storage area SA1 by controlling the nonvolatile memory 430 instead of the S235. The server controller 410 may further delete the information associated with the device information DVp (here, the state ST) from the first storage area SA1.

(8) In S270 (FIG. 4) performed when the progress response (FIG. 4: S255) is not received by the MFP 100 (for example, when the progress response is not received before the third waiting time T3 elapses from the transmission of the progress notification (S225)), the device controller 110 may display various information indicating that the reset process is not completed, without being limited to the above-described message. For example, the display 140 of the MFP 100 may include a lamp (for example, a light emitting diode). The device controller 110 may control the lamp to blink in a particular blinking pattern indicating that the reset process is not completed. The blinking pattern is a pattern representing a temporal change in the lighting state (light on or light off) of the lamp. The display of information (for example, S270) may be omitted. Alternatively, the device controller 110 may transmit information indicating that the reset process is not completed to an external device other than the MFP 100 and the server system 200. For example, the device controller 110 may transmit an electronic message (for example, an e-mail) indicating that the reset process is not completed. The destination of the electronic message may be specified by the user in the registration process of the service (for example, the user's email address). The transmitted information is received by a device (for example, a terminal device such as a smartphone) associated with the destination. The destination of the electronic message may be included in the communication information SSp.

(9) In a case where the progress notification (FIG. 4: S225) is not received by the management server 400 (for example, when the progress notification is not received before the second waiting time T2 elapses from the transmission of the start response (FIG. 3: S155)), the server controller 410 transmits a notification indicating the start of the reset process to the service server 300 in S365 (FIG. 5) or S410 (FIG. 6). The service processor 310 may perform various processes suitable for the service in response to the notification indicating the start of the reset process.

For example, the service may be a non-charging service (for example, a remote printing service). In this case, the service using the MFP 100 may be easily started by a new registration process of the MFP 100. Thus, the service processor 310 may perform a process of deleting the device information DVp from the first storage area SA1. For example, one or both of the first process (FIG. 5: S370) and the second process (FIG. 6: S415) may include a process of deleting the device information DVp from the first storage area SA1.

The service may include a process that involves a change in a value related to a monetary value, such as charging for the number of printed sheets, giving points for replacement of a cartridge of a color material (ink or toner, for example). In this case, when the device information DVp is deleted from the first storage area SA1, disadvantages to the user may occur, such as the loss of the points, double payment due to the re-registration of the MFP 100, for example. Thus, in such a case, the service processor 310 may maintain the device information DVp without deleting the same from the first storage area SA1. Here, the service processor 310 may temporarily stop providing the service associated with the device information DVp. For example, one or both of the first process (FIG. 5: S370) and the second process (FIG. 6: S415) may include a process of temporarily stopping providing the service associated with the device information DVp without deleting the device information DVp.

The first process may include a process not included in the second process. Similarly, the second process may include a process that is not included in the first process. The second process may be the same as the first process.

S360 (FIG. 5) may be omitted. That is, in a case where the progress notification (FIG. 4: S225) is not received by the management server 400 after the transmission of the start response (FIG. 3: S155) (for example, in a case where the progress notification is not received before the second waiting time T2 elapses from the transmission of the start response), the server controller 410 may transmit a notification indicating the start of the reset process to the service server. Then, the service processor 310 may perform various processes suitable for the service in response to the notification.

The transmission of the notification indicating the start of the reset process (for example, S365 and S410) may be omitted. Alternatively, the server controller 410 may transmit the information indicating the start of the reset process to an external device other than the MFP 100 and the server system 200. For example, the server controller 410 may transmit an electronic message (for example, an email) indicating the start of the reset process. The destination of the electronic message may be preset by the business operator that provides the service (for example, an administrator's email address). The transmitted information is received by a device (for example, a terminal device such as a smartphone) associated with the destination.

(10) The process of storing the device information DVp and the setting information SI in the management database D4 (that is, the second storage area SA2 (FIG. 2B)) in association with each other (for example, S115 and S120 in FIG. 3) may be performed at various timings, not limited to the time of registration of the MFP 100. For example, the device controller 110 may periodically transmit the latest setting information SI to the management server 400. The device controller 110 may transmit the setting information SI to the management server 400 in response to the success of the user authentication (S125, S130, S135). The device controller 110 may transmit the setting information SI to the management server 400 in response to the reset instruction (FIG. 3: S140). For example, the device controller 110 may transmit the setting information SI to the management server 400 together with the start notification (FIG. 3: S145).

In either case, the server controller 410 may delete the setting information SI from the management database D4 (that is, from the second storage area SA2) in response to the transmission of the setting information SI to the MFP 100. This reduces the possibility of unintended leakage of the setting information SI. The determination of whether the interruption notification is appropriate (FIG. 5: S312) may be omitted. Further, the transmission (S320) of the setting information SI in the case where the interruption notification (FIG. 5: S310) is received by the server system 200 may be omitted. In this case, steps S325 to S355 by the device controller 110 after the transmission of the interruption notification (S310) may be omitted. Alternatively, the device controller 110 may display information indicating the interruption of the reset process on the display 140.

(11) In a case where the progress notification (FIG. 4: S225) is not received by the server system 200 after the start response (FIG. 3: S155) is transmitted (for example, in a case where the progress notification is not received before the second waiting time T2 elapses from the transmission of the start response), the transmission of the setting information SI (FIG. 5: S320) may be omitted.

(12) In a case where the progress notification (FIG. 4: S225) is not received by the server system 200 after the start response (FIG. 3: S155) is transmitted (for example, in a case where the progress notification is not received before the second waiting time T2 elapses from the transmission of the start response), the communication path between the MFP 100 and the server system 200 may have a malfunction. Thus, the transmission of the setting information SI to the MFP 100 (FIG. 5: S320) may fail. In a case where the progress notification is not received by the server system 200 after the transmission of the start response, the server controller 410 may transmit information indicating that the setting information SI in the MFP 100 may have a defect (for example, partially lost) to an external device other than the MFP 100 and the server system 200. For example, the server controller 410 may transmit an electronic message such as an e-mail. The destination of the electronic message may be preset by the business operator that provides the service. The transmitted information is received by a device associated with the destination.

(13) The processes performed by the MFP 100 and the server system 200 are not limited to the processes of FIGS. 3 to 6, and may be various other processes. For example, S312 (FIG. 5) may be omitted.

(14) The method of communicating with the server system 200 may be various other methods instead of the method using the URL. For example, the MFP 100 and the management server 400 may communicate with each other by always-on connection. In this case, the communication information SSp may include information (for example, a token and a session ID) used for the always-on connection. The always-on connection may be established according to, for example, an extensible messaging and presence protocol (XMPP) or a message queuing telemetry transport (MQTT). Similarly, the MFP 100 and the service server 300 may communicate with each other by always-on connection. The MFP 100 and the management server 400 may transmit information and respond to each other by using the management URL, and may communicate with each other through the always-on connection when a malfunction (for example, a timeout) occurs in the communication.

(15) The service provided by the server system 200 is not limited to the remote printing service, and may be various services. For example, the server system 200 may provide a delivery service of acquiring a remaining amount of a consumable (ink and paper, for example) via the network IT and delivering the consumable to the user according to the remaining amount. The server system 200 may provide a service of acquiring scan data generated by the scan execution unit 170 via the network IT and storing the scan data in a memory of a server (not shown) designated by the user. In this way, the service may be a service unrelated to printing.

The device used for the service is not limited to the MFP 100 (FIG. 1), and may be any device suitable for the service. For example, in a case where the service relates to printing, the device may be various devices including a printer. In a case where the service relates to optical reading of an object, the device may be various devices including a scanner (reading device).

(16) The configuration of the server system is not limited to the configuration of the server system 200 (FIG. 1), and may be various configurations. For example, a plurality of processing modules may share a part of the processing of the management server 400. In this case, the plurality of processing modules as a whole correspond to the management server 400. The processing module may be, for example, a physical computer or a virtualized computer. Similarly, a plurality of processing modules may share a part of the processing of the service server 300. One processing module may perform both the processing of the service server 300 and the processing of the management server 400. The first storage area SA1 may be provided in the management server 400. S245 (FIG. 4), S370 (FIG. 5), and S415 (FIG. 6) may be performed by the management server 400. In this case, the service server 300 may be omitted from the server system 200.

In each of the above embodiments, a part of the configuration realized by hardware may be replaced with software, and conversely, a part or all of the configuration realized by software may be replaced with hardware. For example, the reset process by the MFP 100 may be performed by a dedicated hardware circuit such as an application specific integrated circuit (ASIC).

In a case where a part or all of the functions of the present disclosure are realized by a computer program, the program may be provided in a form stored in a computer-readable recording medium (for example, a non-transitory recording medium). The program may be used in a state of being stored in a recording medium (computer-readable recording medium) that is the same as or different from the recording medium at the time of provision. The “computer-readable recording medium” is not limited to a portable recording medium such as a memory card or a CD-ROM, and may include an internal memory in a computer such as various ROMs, and an external storage connected to a computer such as a hard disk drive.

The above embodiments and modifications may be combined as appropriate. The above embodiment and modifications are intended to facilitate understanding of the present disclosure, and are not intended to limit the present disclosure. The present disclosure may be changed and improved without departing from the scope of the claims, and the present disclosure includes equivalents thereof.

What is claimed is:

1. A communication system comprising a server system and a device used for a service,
the server system comprising:
a server controller; and
a first storage area configured to store device information and user information in association with each other, the device information indicating the device, the user information indicating a user associated with the service,
the device comprising:
a device controller; and
a memory configured to store the device information and setting information, the setting information indicating a setting used for the service,
the device controller configured to:
in response to a reset instruction by a user of the device, transmit a start notification to the server system, the start notification being a notification including the device information;
the server controller configured to:
in a case where the start notification is received by the server system, transmit a start response to the device, the start response being a response to the start notification;
the device controller configured to:
in a first particular case where the start response is received by the device, perform a reset process including deleting the setting information from the memory of the device;
in response to progress of the reset process to a particular stage, transmit a progress notification to the server system, the progress notification indicating the progress of the reset process to the particular stage;
the server controller configured to:
in a second particular case where the progress notification is received by the server system, perform a process for deleting the device information from the first storage area of the server system and transmit a progress response to the device, the progress response being a response to the progress notification; and
the device controller configured to:
in a third particular case where the progress response is received by the device, perform a remainder of the reset process.

2. The communication system according to claim 1, wherein the device controller is configured to:
perform authentication of the user of the device; and
accept the reset instruction in a case where the authentication is successful.

3. The communication system according to claim 1, wherein the device controller is configured to:
not start the reset process in a case where the start response is not received by the device before a first waiting time elapses from transmission of the start notification; and
start the reset process in the first particular case where the start response is received by the device before the first waiting time elapses from the transmission of the start notification.

4. The communication system according to claim 1, wherein the device includes a display; and
wherein the device controller is configured to:
in a case where the progress response is not received by the device, control the display to display information indicating that the reset process is not completed.

5. The communication system according to claim 1, wherein the server system comprises:
a management server including the server controller; and
a service server including the first storage area;
wherein the device controller is configured to transmit the start notification and the progress notification to the management server; and
wherein the server controller is configured to:
in the second particular case where the progress notification is received by the management server, transmit, to the service server, an instruction to delete the device information from the first storage area of the service server; and
in a case where the progress notification is not received by the management server after transmission of the start response, transmit, to the service server, a notification indicating start of the reset process.

6. The communication system according to claim 1, wherein the server system further comprises a second storage area configured to store the device information and the setting information in association with each other;
wherein the device controller is configured to, in a case where a malfunction occurs in the reset process after start of the reset process:
interrupt the reset process; and
transmit an interruption notification to the server system, the interruption notification indicating interruption of the reset process;
wherein the server controller is configured to:
in a case where the interruption notification is received by the server system, transmit the setting information to the device; and
wherein the device controller is configured to:
in a fourth particular case where the setting information is received by the device, store the setting information in the memory of the device.

7. The communication system according to claim 1, wherein the server system further comprises a second storage area configured to store the device information and the setting information in association with each other;
wherein the server controller is configured to:
in a case where the progress notification is not received by the server system after transmission of the start response, transmit the setting information to the device; and
wherein the device controller is configured to:
in a case where the setting information is received by the device, store the setting information in the memory of the device.

8. The communication system according to claim 1, wherein the second particular case is a case where the progress notification is received by the server system before a second waiting time elapses from transmission of the start response.

9. The communication system according to claim 1, wherein the third particular case is a case where the progress response is received by the device before a third waiting time elapses from transmission of the progress notification.

10. The communication system according to claim 6, wherein the server system comprises:
a management server including the server controller; and
a service server including the first storage area; and
wherein the server controller is configured to:
determine whether transmission of the setting information is successful;
in a case where the transmission of the setting information is successful, transmit a first reset notification to the service server, the first reset notification indicating that the setting of the device have been restored; and
in a case where the transmission of the setting information is not successful, transmit a second reset notification to the service server, the second reset notification indicating that information stored in the device has been partially deleted.

11. A management server configured to communicate with a service server and a device used for a service,
the management server comprising a server controller,
the service server comprising a first storage area configured to store device information and user information in association with each other, the device information indicating the device, the user information indicating a user associated with the service,
the device comprising a memory configured to store the device information and setting information, the setting information indicating a setting used for the service,
the server controller configured to:
in a particular case where a progress notification from the device is received by the management server, transmit, to the service server, an instruction to delete the device information from the first storage area of the service server, the progress notification being a notification transmitted by the device in response to progress of a reset process to a particular stage, the reset process including deleting the setting information from the memory of the device.

12. The management server according to claim 11, wherein the server controller is configured to:
in a case where a start notification is received by the management server, transmit a start response to the device, the start response being a response to the start notification;
in the particular case where the progress notification is received by the management server, transmit, to the service server, an instruction to delete the device information from the first storage area of the service server; and
in a case where the progress notification is not received by the management server after transmission of the start response, transmit, to the service server, a notification indicating start of the reset process.

13. The management server according to claim 12, further comprising a second storage area configured to store the device information and the setting information in association with each other,
wherein the server controller is configured to:
in a case where the progress notification is not received by the management server after transmission of the start response, transmit the setting information to the device.

14. The management server according to claim 12, wherein the particular case is a case where the progress notification is received by the management server before a particular waiting time elapses from transmission of the start response.

15. A device used for a service and configured to communicate with a server system, the device comprising:
a device controller; and
a memory configured to store device information and setting information, the device information indicating the device, the setting information indicating a setting used for the service,
the device controller configured to:
in response to a reset instruction by a user of the device, transmit a start notification to the server system, the start notification being a notification including the device information;
in a case where a start response is not received by the device before a first waiting time elapses from transmission of the start notification, not start a reset process including deleting the setting information from the memory of the device, the start response being a response from the server system in response to the start notification;
in a case where the start response is received by the device before the first waiting time elapses from the transmission of the start notification, start the reset process;
in response to progress of the reset process to a particular stage, transmit a progress notification to the server system, the progress notification indicating the progress of the reset process to the particular stage; and
in a particular case where a progress response is received by the device, perform a remainder of the reset process, the progress response being a response from the server system in response to the progress notification.

16. The device according to claim 15, wherein the device controller is configured to:
perform authentication of the user of the device; and
accept the reset instruction in a case where the authentication is successful.

17. The device according to claim 15, further comprising a display,
wherein the device controller is configured to:
in a case where the progress response is not received by the device, control the display to display information indicating that the reset process is not completed.

18. The device according to claim 15, wherein the device controller is configured to:
in a case where a malfunction occurs in the reset process after start of the reset process:
interrupt the reset process; and
transmit an interruption notification to the server system, the interruption notification indicating interruption of the reset process; and
in a case where the setting information is received by the device, store the setting information in the memory.

19. The device according to claim 15, wherein the particular case is a case where the progress response is received by the device before another waiting time elapses from transmission of the progress notification.
